(19) United States
(12) Patent Application Publication
(10) Pub. No.: US 2005/0098587 A1
(43) Pub. Date: May 12, 2005

(54) Fingertip pusher

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/704,960

(22) Filed: Nov. 10, 2003

(51) Int. Cl. B67D 5/42

(52) U.S. Cl. 222/386

(57) ABSTRACT

A small piston operated by fingertip pressure to extract a liquid or cream from a housing such as a hollow tube is disclosed. The fingertip pusher comprises of a bullet shaped piston with a compression surface and a sloping pushing surface. The compression surface is generally flat and the sloping surface is a conical convex surface. In one embodiment, the fingertip pusher comprises of a piston with two ends that are generally in the shape of a bullet tip. In this embodiment, the fingertip pusher may be used both to extract a liquid or cream and to collect a specimen by generating a vacuum to retrieve the specimen.

### BACKGROUND-FIELD OF INVENTION

The present invention relates generally to a small piston. More specifically the present invention is a small piston operated by fingertips.

### BACKGROUND-DESCRIPTION OF RELATED ART

Applicators for liquids and viscous substances such as creams come in various forms and sizes. A common applicator is the cotton swab that comprises of an elongated handle and an absorbent tip at one or both ends of the elongated handle. The elongated handle may be made of a variety of material such as wood, paper, or plastic. The elongated handle may be a solid member or a hollow tube. The absorbent tip may be made of cotton or foam. Some designs incorporate a liquid into the hollow tube of the elongated handle to form a self-contained applicator. However, these designs are not generally suitable for viscous substances such as creams or lotions because the viscous substance will not flow out of the hollow tube easily. Furthermore, the rate of extraction of the liquid or cream cannot be controlled precisely. The present invention is suitable for use to precisely extract both liquids and viscous substances at any desired rate from the hollow tube of the applicator.

### SUMMARY OF THE INVENTION

The present invention is a small piston that is operated by fingertip pressure to extract a liquid or cream from a housing such as a hollow tube. In the preferred embodiment the fingertip pusher comprises of a bullet shaped piston with a compression surface and a sloping pushing surface. In the preferred embodiment, the compression surface is generally flat and the sloping surface is a conical convex surface. In another embodiment, the fingertip pusher comprises of a piston with two ends that are generally in the shape of a bullet tip. In this embodiment, the fingertip pusher may be used both to extract a liquid or cream and to collect a specimen by generating a vacuum to retrieve the specimen.

### BRIEF DESCRIPTION OF THE DRAWINGS

FIG. 1 shows the preferred embodiment of the fingertip pusher.

FIG. 2 shows another embodiment of the fingertip pusher.

FIG. 3 shows another embodiment of the fingertip pusher.

FIG. 4 shows another embodiment of the fingertip pusher.

FIG. 5 shows another embodiment of the fingertip pusher.

FIG. 6 shows another embodiment of the fingertip pusher.

FIG. 7 shows another embodiment of the fingertip pusher.

FIG. 8 shows another embodiment of the fingertip pusher.

FIG. 9 shows another embodiment of the fingertip pusher.

FIG. 10 shows another embodiment of the fingertip pusher.

### DETAILED DESCRIPTION OF THE PREFERRED EMBODIMENT

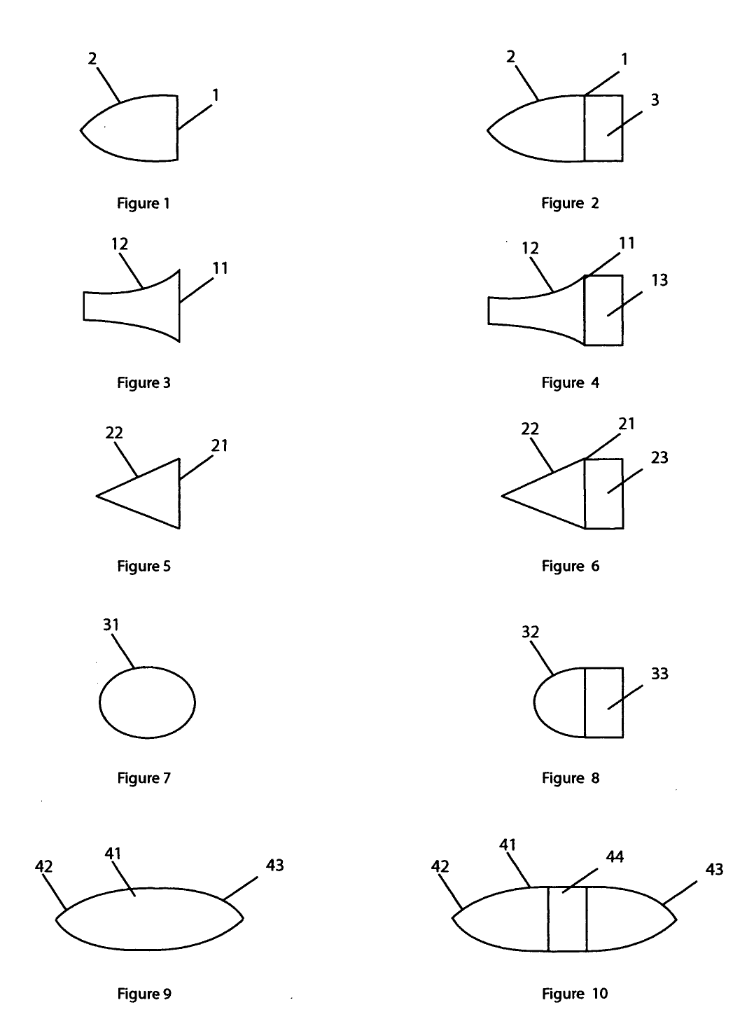

FIG. 1 shows the preferred embodiment of the present invention. In the preferred embodiment, the fingertip pusher comprises of a bullet shaped piston with a compression surface 1 and a sloping pushing surface 2. The compression surface 1 is generally flat or with a slight curvature and the sloping pushing surface 2 is a conical convex surface. The fingertip pusher may be inserted into a hollow tube housing with approximately the same inside diameter as the outside diameter of the fingertip pusher to enable complete and controlled extraction of the content of the hollow tube housing.

In this application, the fingertip pusher is inserted into a hollow tube housing with the compression surface 1 towards the liquid or cream to be extracted. Upon application of pressure from the fingertips through squeezing the hollow tube housing at the position of the sloping pushing surface 2, the sloping pushing surface 2 will redirect the pressure into a force in the horizontal direction to urge the piston toward the liquid or cream thereby forcing the liquid or cream out of the other end of the hollow tube housing.

The rate of extraction and the amount of liquid or cream extracted is easily controlled by the fingertip pressure and the profile of the sloping pushing surface 2. A large pressure from the fingertip will propel the piston faster. A small pressure from the fingertip will propel the piston slower. A fingertip pusher with a long sloping pushing surface 2 will move the piston a longer distance than a short sloping pushing surface 2. The length of the sloping pushing surface 2 may be predetermined to preset the distance of travel of the fingertip pusher, thereby the quantity of the extracted liquid or cream, with each movement of the fingertip pusher.

FIG. 2 shows another embodiment of the fingertip pusher comprising a bullet shaped piston with a compression surface 1 and a sloping pushing surface 2 and a sealing material 3 such as rubber or silicone affixed to the compression surface 1 to provide better sealing between the fingertip pusher and the hollow tube housing. In this embodiment, the bullet shaped piston may be made of a relatively rigid material and may be of a smaller diameter than the inside diameter of the hollow tube housing since it is not required to provide the sealing function. The sealing material 3 may also be affixed around the circumference of the compression surface 1 to mate with the inside diameter of the hollow tube housing.

FIG. 3 shows another embodiment of the fingertip pusher comprising of a bullet shaped piston with a compression surface 11 and a sloping pushing surface 12. The compression surface 11 is generally flat or with a slight curvature and the sloping pushing surface 12 is a conical convex surface. The fingertip pusher may be inserted into a hollow tube housing with approximately the same inside diameter as the outside diameter of the fingertip pusher to enable complete and controlled extraction of the content.

FIG. 4 shows another embodiment of the fingertip pusher comprising a bullet shaped piston with a compression surface 11 and a sloping pushing surface 12 and a sealing material 13 such as rubber or silicone affixed to the compression surface 11 to provide better sealing between the fingertip pusher and the hollow tube housing. In this embodiment, the bullet shaped piston may be made of a relatively rigid material and may be of a smaller diameter than the inside diameter of the hollow tube housing since it is not required to provide the sealing function. The sealing material 13 may also be affixed around the circumference of the compression surface 11 to mate with the inside diameter of the hollow tube housing.

FIG. 5 shows another embodiment of the fingertip pusher comprising of a conical shaped piston with a compression surface 21 and a sloping pushing surface 22. The compression surface 21 is generally flat or with a slight curvature and the sloping pushing surface 22 is a conical flat surface. The fingertip pusher may be inserted into a hollow tube housing with approximately the same inside diameter as the outside diameter of the fingertip pusher to enable complete and controlled extraction of the content.

FIG. 6 shows another embodiment of the fingertip pusher comprising a conical shaped piston with a compression surface 21 and a sloping pushing surface 22 and a sealing material 23 such as rubber or silicone affixed to the compression surface 21 to provide better sealing between the fingertip pusher and the hollow tube housing. In this embodiment, the conical shaped piston may be made of a relatively rigid material and may be of a smaller diameter than the inside diameter of the hollow tube housing since it is not required to provide the sealing function. The sealing material 23 may also be affixed around the circumference of the compression surface 21 to mate with the inside diameter of the hollow tube housing.

FIG. 7 shows another embodiment of the fingertip pusher comprising of a spherical shaped piston 31. The fingertip pusher may be inserted into a hollow tube housing with approximately the same inside diameter as the outside diameter of the fingertip pusher to enable complete and controlled extraction of the content.

FIG. 8 shows another embodiment of the fingertip pusher comprising a semispherical shaped piston 32 and a sealing material 33 such as rubber or silicone affixed to the flat surface of the semispherical shaped piston 32 to provide better sealing between the fingertip pusher and the hollow tube housing. In this embodiment, the semispherical shaped piston 32 may be made of a relatively rigid material and may be of a smaller diameter than the inside diameter of the hollow tube housing since it is not required to provide the sealing function. The sealing material 33 may also be affixed around the circumference of the diameter of the semispherical shaped piston 32 to mate with the inside diameter of the hollow tube housing.

FIG. 9 shows another embodiment of the fingertip pusher comprising a piston 41 with two ends 42, 43 that are generally in the shape of a bullet tip. Any of the previously disclosed shapes for the piston may also be used at each end. In this embodiment, the fingertip pusher may be used both to extract a liquid or cream and to collect a specimen by generating a vacuum to retrieve the specimen. The fingertip pusher may be inserted into a hollow tube housing with approximately the same inside diameter as the outside diameter of the fingertip pusher to enable complete and controlled extraction and collection of the content. A hollow tube housing with the fingertip pusher may be used to collect a specimen by inserting an open end of the hollow tube housing into the specimen to be collected and then urge the fingertip pusher away from the open end of the hollow tube housing thereby generating in a vacuum in the enclosed chamber which will draw the specimen into the enclosed chamber.

FIG. 10 shows another embodiment of the fingertip pusher comprising a piston 41 with two ends 42, 43 that are generally in the shape of a bullet tip and a sealing material 44 such as rubber or silicone affixed between the two ends 42, 43 to provide better sealing between the fingertip pusher and the hollow tube housing. In this embodiment, the bullet shaped piston 41 may be made of a relatively rigid material and may be of a smaller diameter than the inside diameter of the hollow tube housing since it is not required to provide the sealing function. Any of the previously disclosed shapes for the piston may also be used at each end. In this embodiment, the fingertip pusher may be used both to extract a liquid or cream and to collect a specimen by generating a vacuum to retrieve the specimen.

Although the description above contains many specificities, these should not be construed as limiting the scope of the invention but as merely providing illustrations of some of the presently preferred embodiments of this invention. Thus the scope of the invention should be determined by the appended claims and their legal equivalents, rather than by the examples given.

1. A fingertip pusher comprising a bullet shaped piston with a compression surface and a sloping pushing surface wherein the fingertip pusher may be inserted into a hollow tube housing with approximately the same inside diameter as the outside diameter of the fingertip pusher to enable complete and controlled extraction of the content of the hollow tube housing.

2. A fingertip pusher as in claim 1, wherein said compression surface is generally flat or with a slight curvature.

3. A fingertip pusher as in claim 1, wherein said sloping pushing surface is a conical convex surface.

4. A fingertip pusher as in claim 1, wherein said sloping pushing surface is a conical concave surface.

5. A fingertip pusher as in claim 1, wherein said sloping pushing surface is a conical flat surface.

6. A fingertip pusher as in claim 1, wherein said piston is a sphere.

7. A fingertip pusher as in claim 1, wherein said piston has two ends that are each generally in the shape of a conical convex surface.

8. A fingertip pusher as in claim 1, wherein said piston has two ends that are each generally in the shape of a conical concave surface.

9. A fingertip pusher as in claim 1, wherein said piston has two ends that are each generally in the shape of a conical flat surface.

10. A fingertip pusher comprising a bullet shaped piston with a pushing surface on one end and a compression surface on the other end with an elastic seal affixed on or near the compression surface wherein the fingertip pusher may be inserted into a hollow tube housing with approximately the same inside diameter as the outside diameter of the elastic seal to enable complete and controlled extraction of the content of the hollow tube housing.

11. A fingertip pusher as in claim 10, wherein said compression surface is generally flat or with a slight curvature.

12. A fingertip pusher as in claim 10, wherein said sloping pushing surface is a conical convex surface.

13. A fingertip pusher as in claim 10, wherein said sloping pushing surface is a conical concave surface.

14. A fingertip pusher as in claim 10, wherein said sloping pushing surface is a conical flat surface.

15. A fingertip pusher comprising a piston with a semisphere at one end and an elastic seal affixed on the other end or around the diameter of the semisphere wherein the fingertip pusher may be inserted into a hollow tube housing with approximately the same inside diameter as the outside diameter of the elastic seal to enable complete and controlled extraction of the content of the hollow tube housing.

16. A fingertip pusher comprising a piston with two ends that are each generally in the shape of a bullet tip with an elastic seal affixed between the two ends wherein the fingertip pusher may be inserted into a hollow tube housing with approximately the same inside diameter as the outside diameter of the elastic seal to enable complete and controlled extraction of the content of the hollow tube housing and also collection of a specimen.

17. A fingertip pusher as in claim 16, wherein said piston has two ends that are each generally in the shape of a conical convex surface.

18. A fingertip pusher as in claim 16, wherein said piston has two ends that are each generally in the shape of a conical concave surface.

19. A fingertip pusher as in claim 16, wherein said piston has two ends that are each generally in the shape of a conical flat surface.
